(19) United States
(12) Patent Application Publication
(10) Pub. No.: US 2015/0135138 A1
(43) Pub. Date: May 14, 2015

(54) RATING AN ITEM WITH A COMMUNICATION DEVICE

(71) Applicant: Abraham Reichert, Modiin (IL)

(72) Inventor: Abraham Reichert, Modiin (IL)

(21) Appl. No.: 14/078,587

(22) Filed: Nov. 13, 2013

(51) Int. Cl. G06F 3/0481

(52) U.S. Cl. CPC G06F 3/04817
USPC 715/810

(57) ABSTRACT

An icon for rating an item, the icon including a graduated indication of a degree of liking or disliking the item.

### CROSS-REFERENCE TO OTHER APPLICATIONS This application claims priority from U.S. Provisional Patent Application 61/726661, filed Nov. 15, 2012, which is incorporated herein by reference.

### FIELD OF THE INVENTION

The present invention relates generally to providing a rating of an item with a communication device, and specifically to an icon (e.g., a thumb-up or thumb-down icon) used for rating an item.

### BACKGROUND OF THE INVENTION

Many methods are known in the prior art for rating content items, such as items on a social network (e.g., FACEBOOK), video content (e.g., songs, film clips, etc.) and many others, according to a user's expressed preferences. In general, rating involves assigning a Boolean rating of “like” or “dislike” to the particular item. Well-known examples include numerical ratings, such as a scale from one to ten, one being least favorite and ten being most favorite, and icons, such as a “thumbs up” for like and “thumbs down” for dislike.

### SUMMARY OF THE INVENTION

The present invention seeks to provide an improved icon (e.g., a thumb-up or thumb-down icon) for rating an item, as is described more in detail hereinbelow. In particular, the present invention seeks to provide an icon which provides a graduated indication of degree of liking an item.

There is thus provided in accordance with a non-limiting embodiment of the present invention an article including an icon for rating an item, the icon including a graduated indication of a degree of liking or disliking the item.

In accordance with an embodiment of the present invention the graduated indication includes levels of filling an interior space of the icon, wherein gradually increased filling of the interior space indicates a stronger liking or disliking of the item.

In accordance with an embodiment of the present invention the filling includes filling the interior space with distinguishably different elements. For example, the elements may differ by color, contour, size or shape. In another embodiment, the graduated indication includes different brightness levels of the icon.

In yet another embodiment, the graduated indication includes different colors or different sizes of the icon.

In another embodiment, the graduated indication includes graduated punctuation marks adjacent the icon. In yet another embodiment, the graduated indication includes a numerical scale adjacent the icon. In still another embodiment, the graduated indication includes graduated levels of a caricature associated with the icon.

There is also provided in accordance with a non-limiting embodiment of the present invention a method including using an icon for rating an item, the icon including a graduated indication of a degree of liking or disliking the item. For example, a pop-up window on a screen can be used to select the graduated indication, and/or a computer pointing device function can be used to select the graduated indication.

The rating of the user may be sent (by Internet or other communication method) to an information receiver, such as but not limited to, friends, family, advertisers, publicity firms, places of businesses, points of sale, vendors, etc., wherein the graduated rating provides important marketing information to the receiver of such information.

### BRIEF DESCRIPTION OF THE DRAWINGS

The present invention will be understood and appreciated more fully from the following detailed description taken in conjunction with the drawings in which:

FIG. 1 is a simplified pictorial illustration of an icon for rating an item, constructed and operative in accordance with an embodiment of the present invention;

FIG. 2 is a simplified pictorial illustration of an icon for rating an item, constructed and operative in accordance with another embodiment of the present invention;

FIG. 3 is a simplified pictorial illustration of an icon for rating an item, constructed and operative in accordance with yet another embodiment of the present invention; and

FIG. 4 is a simplified pictorial illustration of an icon for rating an item, constructed and operative in accordance with still another embodiment of the present invention.

### DETAILED DESCRIPTION OF EMBODIMENTS

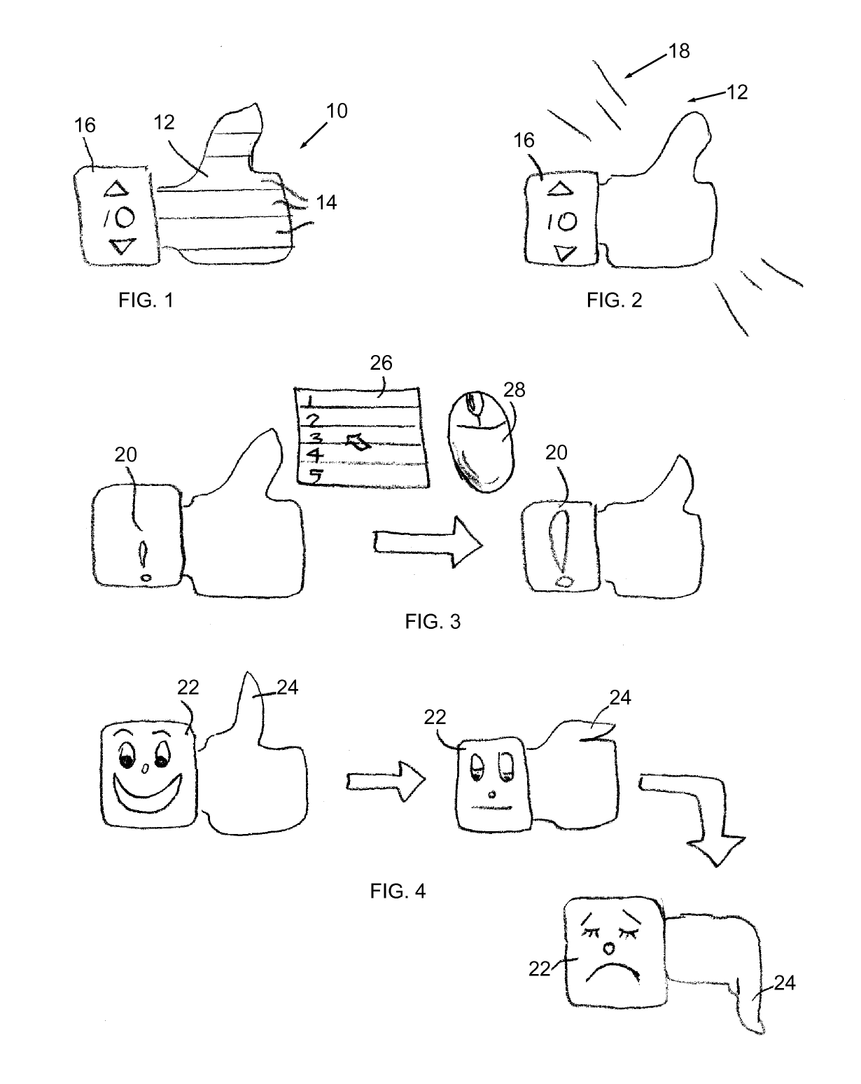

Reference is now made to FIG. 1, which illustrates an icon 10 for rating items, constructed and operative in accordance with an embodiment of the present invention.

Icon 10 is shown as a thumb sign, but it is appreciated that the invention is not limited to a thumb, and can include other indications, such as but not limited to, a star, ball, face, and many others. Icon 10 includes a graduated indication 12 of a degree of liking or disliking the item.

In the illustrated embodiment of FIG. 1, the graduated indication 12 includes levels of filling an interior space of icon 10. By gradually increasing the filling of the interior space, the user indicates a stronger liking of the item (or disliking of the item if the thumb is pointing down).

For example, the interior space may be filled with distinguishably different elements 14. For example, the elements 14 may differ by color (e.g., rainbow colors, shades of a certain color, different cross-hatching or diagonal line shading, etc.), contour, size or shape. In the illustrated embodiment, the graduated indication 12 further includes a numerical scale 16 adjacent icon 10. As the user increases the preference level, the numbers increase, for example, from 1 to 10.

Reference is now made to FIG. 2. In this embodiment, the graduated indication 12 includes different brightness levels 18 of the icon. Additionally or alternatively, the graduated indication 12 may include different colors or different sizes of the icon.

Reference is now made to FIG. 3. In this embodiment, the graduated indication includes graduated punctuation marks 20 adjacent icon 10.

Reference is now made to FIG. 4. In this embodiment, the graduated indication includes graduated levels of a caricature 22 associated with the icon. A thumb 24 of the icon points up when the highest level of preference is indicated. The thumb 24 is horizontal when the medium level of preference is indicated. The thumb 24 points down when the lowest level of preference is indicated.

As exemplarily shown in FIG. 3 (although these features hold for all embodiments), a pop-up window 26 on a screen can be used to select the graduated indication. Pop-up window 26 may be accessed by a pointing device, such as right-clicking on a mouse 28. As another example, scrolling the scroll button of the mouse 28 can be used to select the graduated indication. Of course, other pointing devices or other communication devices can be used to effect the selection and send the graduated indication to information receiver, such as but not limited to, friends, family, advertisers, publicity firms, places of businesses, points of sale, vendors, etc.

What is claimed is:

1. An article comprising:
an icon for rating an item, said icon comprising a graduated indication of a degree of liking or disliking the item.

2. The article according to claim 1, wherein said graduated indication comprises levels of filling an interior space of said icon, wherein gradually increased filling of the interior space indicates a stronger liking or disliking of the item.

3. The article according to claim 2, wherein said filling comprises filling the interior space with distinguishably different elements.

4. The article according to claim 3, wherein said elements differ by color.

5. The article according to claim 3, wherein said elements differ by contour.

6. The article according to claim 3, wherein said elements differ by size or shape.

7. The article according to claim 1, wherein said graduated indication comprises different brightness levels of said icon.

8. The article according to claim 1, wherein said graduated indication comprises different colors of said icon.

9. The article according to claim 1, wherein said graduated indication comprises different sizes of said icon.

10. The article according to claim 1, wherein said graduated indication comprises graduated punctuation marks adjacent said icon.

11. The article according to claim 1, wherein said graduated indication comprises a numerical scale adjacent said icon.

12. The article according to claim 1, wherein said graduated indication comprises graduated levels of a caricature associated with said icon.

13. A method comprising:
using an icon for rating an item, said icon comprising a graduated indication of a degree of liking or disliking the item.

14. The method according to claim 13, comprising using a pop-up window on a screen to select said graduated indication.

15. The method according to claim 13, further comprising sending said graduated indication to an information receiver.
